(19) United States
(12) Patent Application Publication
(10) Pub. No.: US 2022/0061593 A1
(43) Pub. Date: Mar. 3, 2022

(54) PORTABLE HANDWASHING SYSTEM

(71) Applicant: Anet Milian, Fort Lauderdale, FL (US)

(72) Inventor: Anet Milian, Fort Lauderdale, FL (US)

(21) Appl. No.: 17/009,196

(22) Filed: Sep. 1, 2020

(51) Int. Cl. A47K 1/02; A47K 10/08; A47K 5/02

(52) U.S. Cl. CPC A47K 1/02; B60R 15/02; A47K 5/02; A47K 10/08

(57) ABSTRACT

A portable handwashing system is disclosed, comprising a reservoir configured to retain a volume of water therein, the reservoir releasably engaged with a vehicle. At least one hose expels the volume of water from the reservoir onto the user. At least one towel holder retains a hand drying material thereon and at least one soap holder retains one or more hand washing products.

### TECHNICAL FIELD

The embodiments generally relate to portable wash systems and, more particularly, to gravity fed handwashing systems for use in a vehicle.

### BACKGROUND

Handwashing is an important factor of hygiene. It is well known that disease-causing pathogens are often spread through contact of an individual's hands with the hands of other individuals and surfaces which are frequently contacted. Frequent handwashing is accepted as an effective and convenient means to improve and protect general public health.

Portable handwashing techniques are known in the arts. Devices include portable sanitizing bottles are often carried and used by individuals in public places. These devices are often carried in a pocket or handbag and deployed when needed. Also, portable wash stations have been used by campers, beachgoers, picnickers, and at parties where running water is not readily available. These systems often use manually pumped water tanks, which forcibly drive water through a spout onto the user. For example, many systems use manually driven positive pressure pumps to expel water.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein provide a portable handwashing system, comprising a reservoir configured to retain a volume of water therein, the reservoir releasably engaged with a vehicle. At least one hose expels the volume of water from the reservoir onto the user. At least one towel holder retains a hand drying material thereon, and at least one soap holder retains one or more hand washing products.

The system provides a portable container, which stores water and allows the user to wash their hands in locations where running water may not be available. The reservoir may be configured to retain hand washing items including towels, cleaning supplies, etc. to ensure proper handwashing and bodily cleaning techniques are possible. The system is gravity fed such that the user does not need to actively or passively pump water from the reservoir through the hose. In such, the system can be operated without an auxiliary power supply.

In one aspect, the reservoir includes one or more hook and loop systems provided on a bottom of the reservoir.

In one aspect, the one or more hook and loop systems releasably engages with a trunk of the vehicle.

In one aspect, the reservoir comprises an interior having a false bottom.

In one aspect, the false bottom is positioned above the bottom of the reservoir.

In one aspect, the hose is positioned between the false bottom and the bottom.

In one aspect, the at least one towel holder and the at least one soap holder are positioned on one or more sidewalls of the reservoir.

In one aspect, the reservoir comprises a top, which further comprises a lid.

In one aspect, the lid is threadingly engaged with the top.

In one aspect, the top comprises an air inlet.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a top perspective view of the portable handwashing system disposed within a vehicle, according to some embodiments;

FIG. 2 illustrates a perspective view of the portable handwashing system, according to some embodiments;

FIG. 3 illustrates a cross-section of the reservoir, according to some embodiments;

FIG. 4 illustrates a top plan view of the reservoir, according to some embodiments; and

FIG. 5 illustrates a perspective view of a user washing their hands using the portable handwashing system, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

As used herein, the “reservoir” relates to a container, which holds a volume of water or other fluid used by the portable handwashing system described herein.

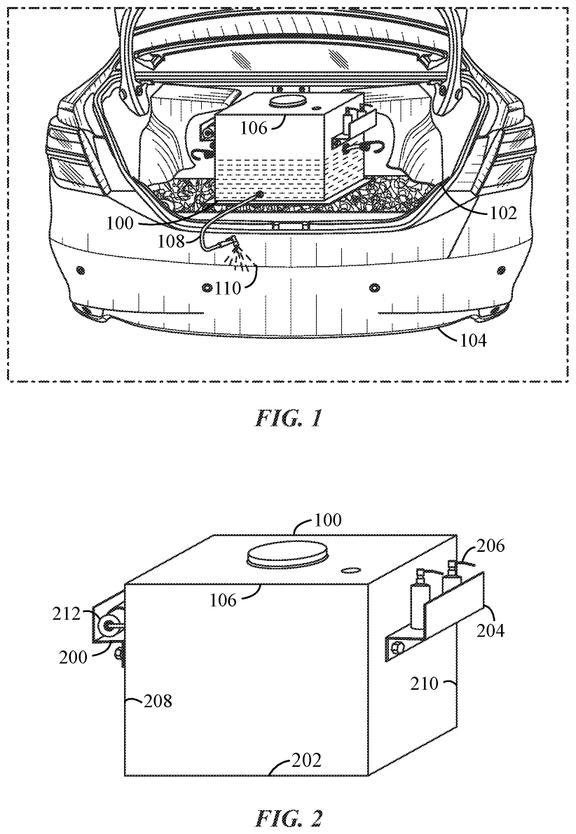

FIG. 1 illustrates a top perspective view of the portable handwashing system 100 disposed within the trunk 102 of a vehicle 104. The portable handwashing system include a reservoir 106, which is dimensioned to be releasable engaged within an interior or on an exterior surface of the vehicle 104. A hose 108 extends from the reservoir 106 and allows the user to extend the hose 108 out of the vehicle 104 and selectively expel water 110 therefrom.

One skilled in the arts will readily understand that the vehicle 104 may include any vehicle, watercraft, aircraft, camper, recreational vehicle, or other vehicle known in the arts. The portable handwashing system 100 may be retained within the interior of the vehicle 104 or on an exterior surface thereof.

FIG. 2 illustrates a perspective view of the portable handwashing system 100 including the reservoir 106, which is illustrated as a cube or rectangular cuboid. One skilled in the arts will readily understand that the reservoir 106 may be constructed in various shapes, sizes, and configurations to be disposed within a variety of vehicles 104, or on the exterior thereof. The towel holder 200 is provided on the exterior 202 of the reservoir 106 to provide a means for retaining towels 212, including, for example, paper towels, napkins, or other washing and drying devices to be retained on the reservoir 106. For example, the towel holder 200 may include a member which receives a roll of paper towels 212 to allow the user to rotate a roll of paper towels 212 and tear paper towel segments therefrom. A soap holder 204 provides a shelf or similar surface, which holds one or more handwashing products 206 (e.g., soap, hand sanitizer, moisturizer, etc.). The towel holder 200 and soap holder 204 may be provided on one or more sidewalls 208,210 of the reservoir to allow the user to readily utilize the towels 212 and/or hand washing products 206 provided on the portable handwashing system 100.

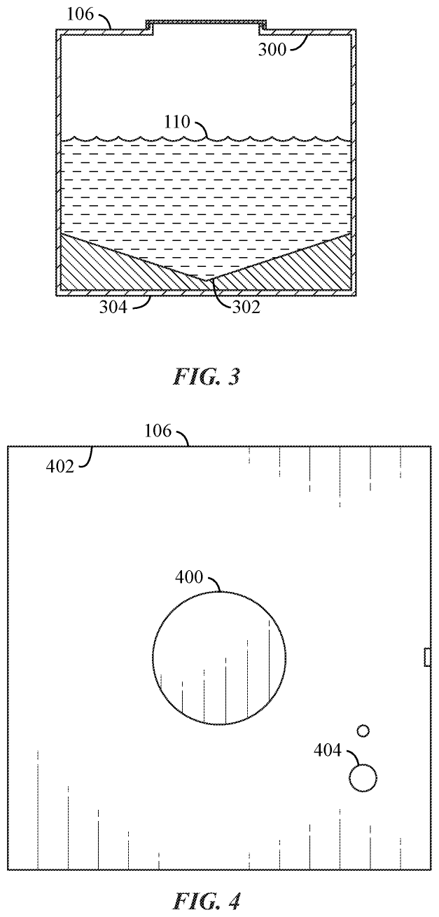

FIG. 3 illustrates a cross-section of the reservoir 106, having a volume of water 110 disposed within an interior 300 of the reservoir 106. The interior 300 includes a false bottom 302 provided at a height within the interior 300 of the reservoir 106 such that the water 110 is retained above the bottom 304 of the reservoir 106. The bottom 304 contacts the surface of the vehicle (e.g., the surface of the trunk). The bottom 304 may include one or more hook and loop strips or segments to retain the reservoir 106 at a fixed point in or on the vehicle. The false bottom 302 ensures that the entire volume of water 110 may be expelled therefrom using a gravity fed system.

In some embodiments, the reservoir 106 may include one or more hooks, which attach to a cord other strap engaged with a surface of the vehicle. For example, the user may attach a cord from the sidewalls 208,210 of the reservoir 106 to the bed of a truck to retain the reservoir 106 in a fixed position therein. On skilled in the arts will readily understand that the reservoir 106 may be retained by straps, cords, elastic components, or rigid members attached between the reservoir 106 and one or more surfaces of the vehicle.

FIG. 4 illustrates a top plan view of the reservoir 106 having a lid 400, which is releasably engaged with a top surface 402 of the reservoir 106. The lid 400 may be threadingly engaged or form a friction fit with an opening of the reservoir 106 such that the user may remove the lid 400 to dispense water 110 into the interior 300 of the reservoir 106. An air inlet 404 is provided on the top surface 402 to allow air to flow into the reservoir 106 as water 110 is emitted from the hose 108. In such, the air inlet 404 allows for a steady flow of water 110 through the hose 108 or other outlet.

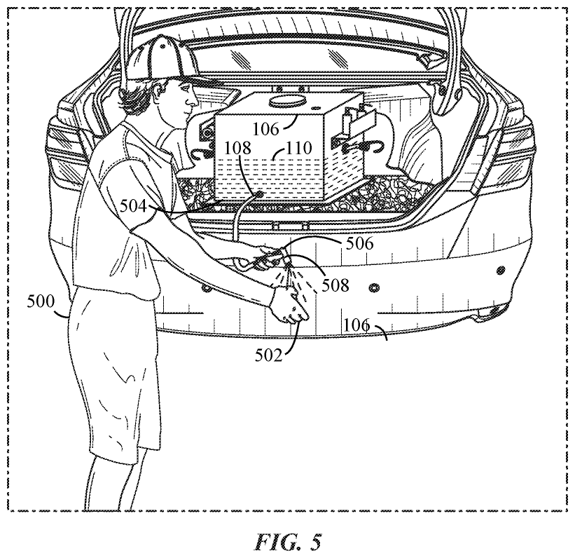

FIG. 5 illustrates a perspective view of a user 500 washing their hands 502 using the portable handwashing system 100. The hose 108 is positioned at a bottom portion 504 of the reservoir 106 below the false bottom 302 such that the gravity forces water 110 out of the hose 108 during use. The hose 108 may include a valve 506 to allow the user to selectively open and close the end of the hose 108 and expel water 110 therefrom. A nozzle 508 may be provided on the end of the hose 108 to direct the expulsion and/or increase the pressure of water 110 emitted therefrom.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A portable handwashing system, comprising:
a reservoir configured to retain a volume of water therein, the reservoir releasably engaged with a vehicle;
at least one hose to expel the volume of water;
at least one towel holder to retain a hand drying material thereon; and
at least one soap holder to retain one or more hand washing products.

2. The portable handwashing system of claim 1, wherein the reservoir includes one or more hook and loop systems provided on a bottom of the reservoir.

3. The portable handwashing system of claim 2, wherein the one or more hook and loop systems releasably engages with a trunk of the vehicle.

4. The portable handwashing system of claim 1, wherein the reservoir comprises an interior having a false bottom.

5. The portable handwashing system of claim 4, wherein the false bottom is positioned above the bottom of the reservoir.

6. The portable handwashing system of claim 5, wherein the hose is positioned between the false bottom and the bottom.

7. The portable handwashing system of claim 6, wherein the at least one towel holder and the at least one soap holder is positioned on one or more sidewalls of the reservoir.

8. The portable handwashing system of claim 1, wherein the reservoir comprises a top comprising a lid.

9. The portable handwashing system of claim 8, wherein the lid is threadingly engaged with the top.

10. The portable handwashing system of claim 9, wherein the top comprises an air inlet.

11. A portable handwashing system, comprising:
a reservoir configured to retain a volume of water therein, the reservoir releasably engaged with a vehicle;
at least one hose to expel the volume of water, the hose extending from the bottom of the reservoir, the hose comprising a valve to permit the user to selectively expel water through a nozzle positioned on the hose;
at least one towel holder to retain a paper towel thereon; and
at least one soap holder to retain one or more hand washing products.

12. The portable handwashing system of claim 1, wherein the reservoir includes one or more hook and loop systems provided on a bottom of the reservoir.

13. The portable handwashing system of claim 12, wherein the one or more hook and loop systems releasably engages with a trunk of the vehicle.

14. The portable handwashing system of claim 13, wherein the reservoir comprises an interior having a false bottom.

15. The portable handwashing system of claim 14, wherein the false bottom is positioned above the bottom of the reservoir.

16. The portable handwashing system of claim 15, wherein the hose is positioned between the false bottom and the bottom.

17. The portable handwashing system of claim 16, wherein the at least one towel holder and the at least one soap holder is positioned on one or more sidewalls of the reservoir.

18. The portable handwashing system of claim 17, wherein the reservoir comprises a top comprising a lid.

19. The portable handwashing system of claim 18, wherein the lid is threadingly engaged with the top.

20. A portable handwashing system, comprising:
a reservoir configured to retain a volume of gravity-fed water therein, the reservoir releasably engaged with a vehicle, the reservoir comprising a top having a threadingly engaged lid and an air inlet;
at least one hose to expel the volume of water, the hose extending from the bottom of the reservoir, the hose comprising a valve to permit the user to selectively expel water through a nozzle positioned on the hose;
at least one towel holder to retain a paper towel thereon; and
at least one soap holder to retain one or more hand washing products, wherein the reservoir is retained on or within the vehicle to provide a portable handwashing system.
